(19) United States
(12) Patent Application Publication
(10) Pub. No.: US 2022/0034438 A1
(43) Pub. Date: Feb. 3, 2022

(54) Toilet Flange Cover

(71) Applicant: Cleve Wallace, Manassas, VA (US)

(72) Inventor: Cleve Wallace, Manassas, VA (US)

(21) Appl. No.: 17/387,818

(22) Filed: Jul. 28, 2021

Related U.S. Application Data
(60) Provisional application No. 63/057,765, filed on Jul. 28, 2020.

(51) Int. Cl. F16L 55/115; E03C 1/28

(52) U.S. Cl. CPC F16L 55/115; E03C 1/28

(57) ABSTRACT

A toilet flange cap with cleaning basin is presented. The toilet flange cap with cleaning basin contains a cap body and a flange seal. The flange seal is connected adjacent to the cap body. The toilet flange cap with cleaning basin allows a user to plug and seal a flange aperture along a toilet flange insert, preventing sewage gas and airborne pathogens from emitting from the flange aperture.

The current application claims a priority to the U.S. Provisional Patent application Ser. No. 63/057,765 filed on Jul. 28, 2020.

### FIELD OF THE INVENTION

The present invention generally relates to safety covers. More specifically, the present invention relates to toilet flange covers.

### BACKGROUND OF THE INVENTION

There is demand for a device to protect people from unwanted sewage fumes and airborne pathogens that are emitted through an exposed toilet flange orifice. Contractors often remove toilets to renovate bathrooms. This leaves an exposed toilet flange orifice that emits sewage fumes and airborne pathogens that poses as hazards to the contractors. Additionally, tools and other loose articles may be lost when dropped in these exposed toilet flange orifices.

Contractors would often retrofit plugs for these exposed toilet flange orifices. These retrofits are unprofessional and do not seal the exposed toilet flange orifice completely, still allowing unwanted sewage fumes and airborne pathogens to emit through. Additionally, these retrofits may slip deeper in the orifice due to being secure loosely along the toilet flange orifice causing clogs. Furthermore, the loosely fitted retrofit plugs are often kicked or knocked loose during renovations, therefore it is an objective of the present invention to provide a secure and sanitized means of plugging an exposed toilet flange orifice. The present invention is intended to address the problems associated with and/or otherwise improve on conventional devices through an innovative toilet flange cover to provide a convenient and effective means of sealing unwanted sewage fumes and airborne pathogens emitted through an expose toilet flange orifice. Furthermore, the present invention features a means to allow contractors to utilize the toilet water system and toilet flange orifice as a wash basin.

### SUMMARY OF THE INVENTION

The toilet flange cap with cleaning basin comprises a cap body and a flange seal. The flange seal is connected adjacent to the cap body. In the preferred embodiment of the present invention, the toilet flange cap with cleaning basin allows a user to plug and seal a flange aperture along a toilet flange insert, preventing sewage gas and airborne pathogens from emitting from the flange aperture. In the preferred embodiment of the present invention, the flange seal is made out of a rubber material, such as, but not limited to silicone, hard rubber, or any other suitable material. In the preferred embodiment of the present invention, the cap body is made out of a rigid material, such as, but not limited to PVC polymer, ABS, aluminum, or any other suitable material.

### BRIEF DESCRIPTION OF THE DRAWINGS

FIG. 1 is a perspective view of the present invention installed along a toilet flange insert.

FIG. 2 is a perspective view of the present invention that shows the toilet flange cap removed from the toilet flange insert.

FIG. 3 is a perspective view of the present invention that shows a basin installed along the toilet flange insert.

FIG. 4 is a top perspective view of the toilet flange cap.

FIG. 5 is a bottom perspective view of the toilet flange cap.

FIG. 6 is a top perspective view of the basin.

FIG. 7 is a bottom perspective view of the basin.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

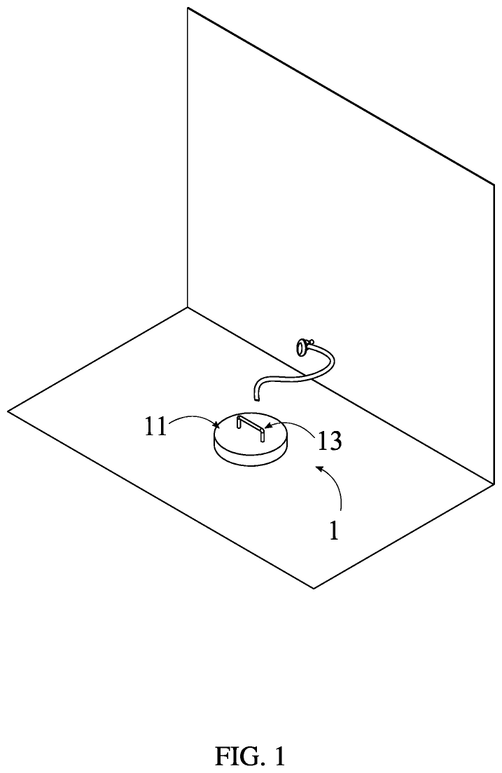

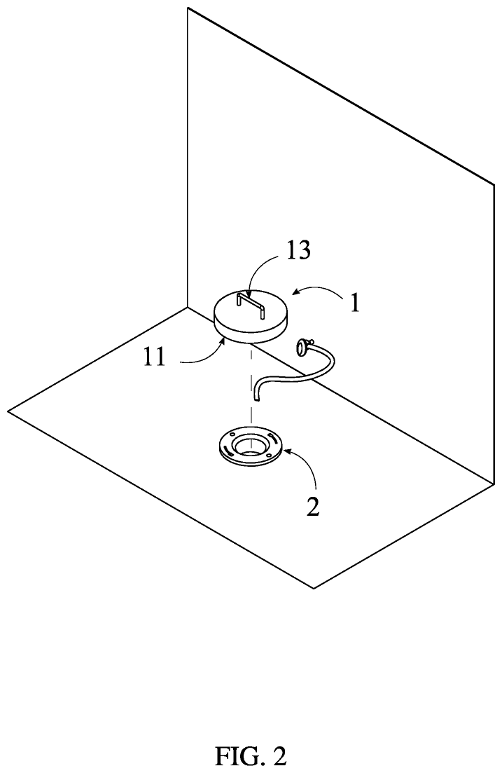

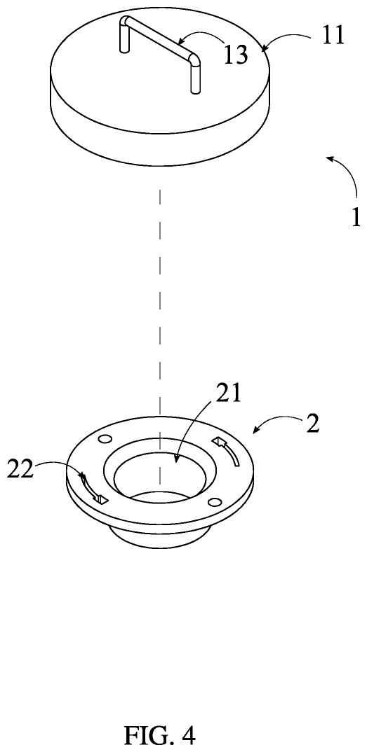

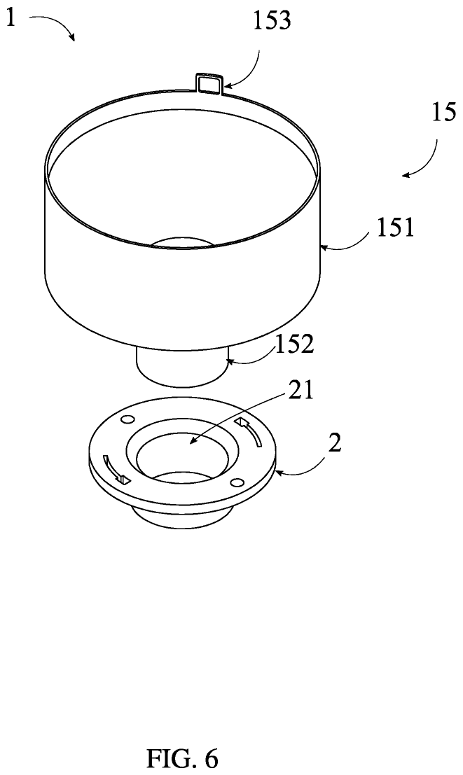

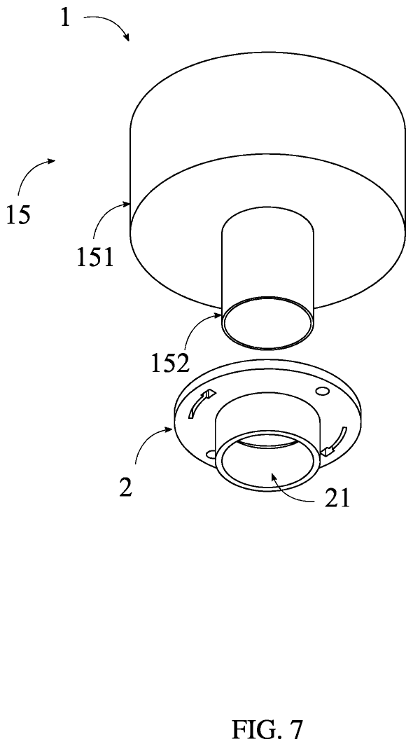

In reference to FIGS. 1-7, the toilet flange cap with cleaning basin 1 comprises a cap body 11 and a flange seal 12. The flange seal 12 is connected adjacent to the cap body 11. In the preferred embodiment of the present invention, the toilet flange cap with cleaning basin 1 allows a user to plug and seal a flange aperture 21 along a toilet flange insert 2, preventing sewage gas and airborne pathogens from emitting from the flange aperture 21. In the preferred embodiment of the present invention, the flange seal 12 is made out of a rubber material, such as, but not limited to silicone, hard rubber, or any other suitable material. In the preferred embodiment of the present invention, the cap body 11 is made out of a rigid material, such as, but not limited to PVC polymer, ABS, aluminum, or any other suitable material.

In reference to FIGS. 1-4, the toilet flange cap with cleaning basin 1 further comprises a handle 13. The handle 13 is connected adjacent to the cap body 11, opposite to the flange seal 12. In the preferred embodiment of the present invention, the handle 13 allows the user to pull the cap body 11 and the flange seal 12 from the toilet flange insert 2. In the preferred embodiment, the flange seal 12 is fitted along the flange aperture 21 such that it is press fitted on.

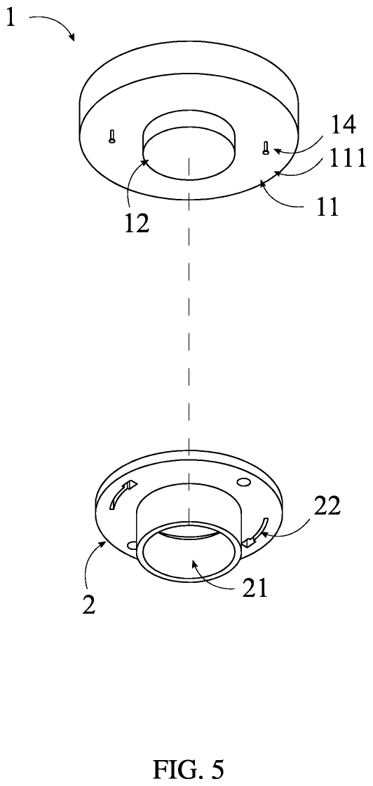

In reference to FIG. 5. the toilet flange cap with cleaning basin 1 further comprises at least one connecting element 14. The cap body 11 comprises a lower surface 111. The flange seal 12 is centrally connected adjacent to the lower surface 111. The at least one connecting element 14 is distributed about the lower surface 111. In the preferred embodiment of the present invention, the at least one connecting element 14 may take the form of twist lock connection tabs that connects and secures along at least one flange connection slot 22, removably attaching the toilet flange body to the toilet flange insert 2.

This further secures the toilet flange body from being knocked over or dislodged during renovations.

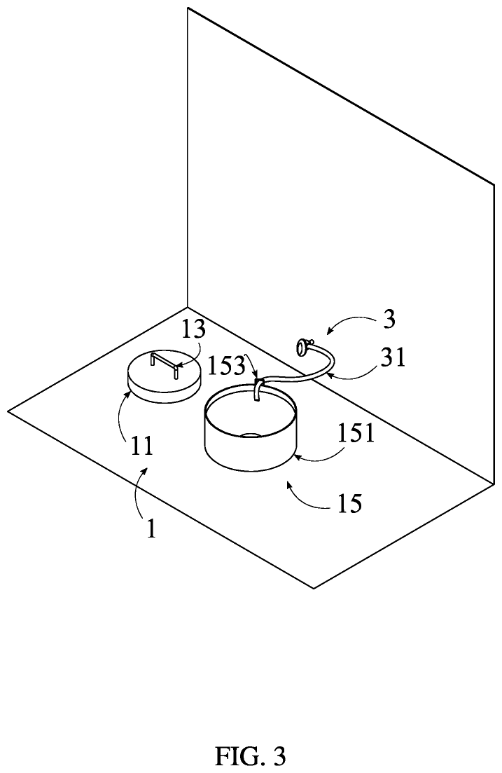

In reference to FIGS. 3 and 6-7, the toilet flange cap with cleaning basin 1 further comprises a basin 15. The basin 15 comprises a basin reservoir 151 and a flange spout 152. The basin reservoir 151 is connected adjacent to the flange spout 152. The basin 15 further comprises a hose holder 153. The hose holder 153 is connected adjacent to the basin reservoir 151, opposite to the flange spout 152. In the preferred embodiment of the present invention, the basin 15 serves as a wash station, adapting the flange aperture 21 as a wash drain. In the preferred embodiment of the present invention, the flange spout 152 connects and secures along the toilet flange insert 2, mounting the basin 15 to the toilet flange insert 2. The basin reservoir 151 serves as a cleaning bowl, allowing users to wash their hands and tools within the basin reservoir 151. In the preferred embodiment of the present invention, the basin 15 utilizes a toilet water system 3 to dispense cleaning water along the basin reservoir 151. The hose 31 of the toilet water system 3 is connected along the hose holder 153 of the basin 15, repurposing the hose 31 as faucet spigot. The user can then activate the toilet water system 3 and dispense wash water along the basin reservoir 151. Once the user is finished washing, the basin 15 is replaced by the cap body 11 and the flange seal 12.

Although the invention has been explained in relation to its preferred embodiment, it is to be understood that many other possible modifications and variations can be made without departing from the spirit and scope of the invention as hereinafter claimed.

What is claimed is:

1. A toilet flange cap with cleaning basin comprising:
a cap body;
a flange seal; and
the flange seal being connected adjacent to the cap body.

2. The toilet flange cap with cleaning basin as claimed in claim 1 comprising:
a handle; and
The handle being connected adjacent to the cap body, opposite to the flange seal.

3. The toilet flange cap with cleaning basin as claimed in claim 1 comprising:
at least one connecting element;
the cap body comprising a lower surface;
the flange seal being centrally connected adjacent to the lower surface;
the at least one connecting element being distributed about the lower surface.

4. The toilet flange cap with cleaning basin as claimed in claim 1 comprising:
a basin;
the basin comprising a basin reservoir and a flange spout; and
the basin reservoir being connected adjacent to the flange spout.

5. The toilet flange cap with cleaning basin as claimed in claim 4 comprising:
the basin further comprising a hose holder; and
the hose holder being connected adjacent to the basin reservoir, opposite to the flange spout.

6. The toilet flange cap with cleaning basin as claimed in claim 1, wherein the flange seal is made out of a rubber material.

7. The toilet flange cap with cleaning basin as claimed in claim 1, wherein the cap body is made out of a rigid material.
